(19) United States
(12) Patent Application Publication
(10) Pub. No.: US 2011/0131827 A1
(43) Pub. Date: Jun. 9, 2011

(54) Ultimate glove dryer

(76) Inventors: Patrick John, Murrieta, CA (US); Jean-Luc Annet, Murrieta, CA (US); Joshua Paul Goldfarb, Huntington Beach, CA (US)

(21) Appl. No.: 12/928,420

(22) Filed: Dec. 9, 2010

Related U.S. Application Data
(60) Provisional application No. 61/283,878, filed on Dec. 9, 2009.

(51) Int. Cl. F26B 21/06

(52) U.S. Cl. 34/72

(57) ABSTRACT

The Ultimate Gear Dryer is a device for drying and deodorizing the inside of athletic gear after it is damp from wear. Primarily intended for use with sport specific gloves and footwear, the device supports the gear being dried. The device combines mechanical suction of stale air from the inside of the athletic gear with the blowing of fresh air that has been passed through a filter into the athletic gear. This device helps remedy conditions that breed germs and foul scents inside the athletic gear.

This application claims priority of application 61/283,878, filed on Dec. 9, 2009, entitled “device for drying all types of athletic gloves, such as boxing gloves, baseball gloves, hockey gloves, etc.”

### TITLE OF THE INVENTION

The Ultimate Gear Dryer is a device for drying and deodorizing all types of athletic gear, primarily gloves and footwear, such as boxing gloves, mixed martial arts gloves, baseball gloves, hockey gloves, hunting gloves, auto and motorcycle racing gloves, ski and snowboarding gloves, and each sports' specific footwear.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

Athletic or sports gear that is in constant contact with an athletes body (like sport specific gloves and footwear) become moist with perspiration from the athlete. In some sports water or melted ice may also attribute to the moisture build-up. If the moisture is not properly removed the gear can become a breading ground for germs, which results in a foul scent and potential infectious disease such as staff infections.

Additionally, athletic gear often contains delicate or natural materials, like leather, that require specific care. The prior art options for drying today do nothing more than blow ambient, and potentially contaminated, air into the gear and do not mechanically facilitate the removal of the trapped stale air inside the athletic gear. Some use heated air which can damage the structure of certain materials like leather. The addition of warmth can further create an environment which promotes germ growth. This scenario can also compact moist, stale-air deeper into the gear.

### BRIEF SUMMARY OF THE INVENTION

The Ultimate Gear Dryer blows clean, filtered air with deodorizer into athletic gear while vacuuming the trapped stale air out. When properly used, this mechanically facilitated air circulation prevents the build-up of germs that lead to foul smells and potential disease. The Ultimate Gear Dryer utilizes no heaters and incorporates room temperature air for the drying and deodorizing process.

### BRIEF DESCRIPTION OF THE SEVERAL VIEWS OF THE DRAWING

FIG. 1 is a top elevation view of the Ultimate Gear Dryer being used to dry four boxing gloves;

FIG. 2 is a front elevation view thereof,

FIG. 3 is a right-side elevation view thereof,

FIG. 4 is a left-side elevation view thereof.

The boxing glove is shown in broken lines for illustrative purposes only and forms no part of the claimed design.

FIG. 5 is an exploded view of the Ultimate Gear Dryer.

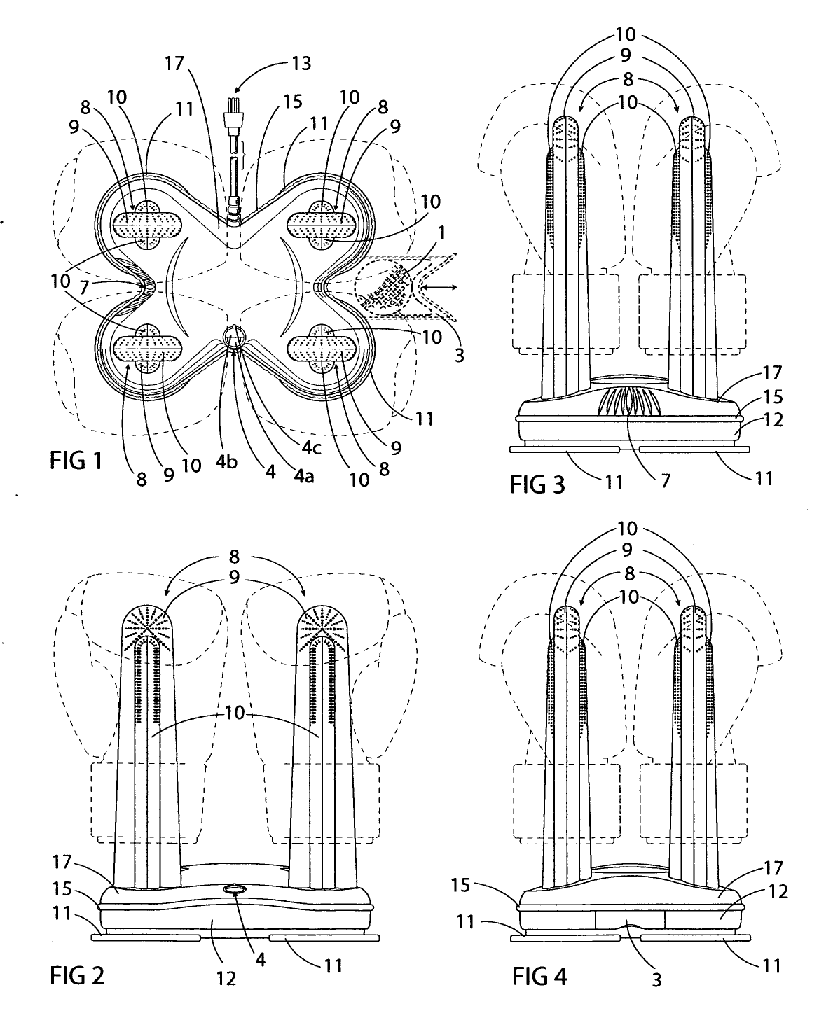

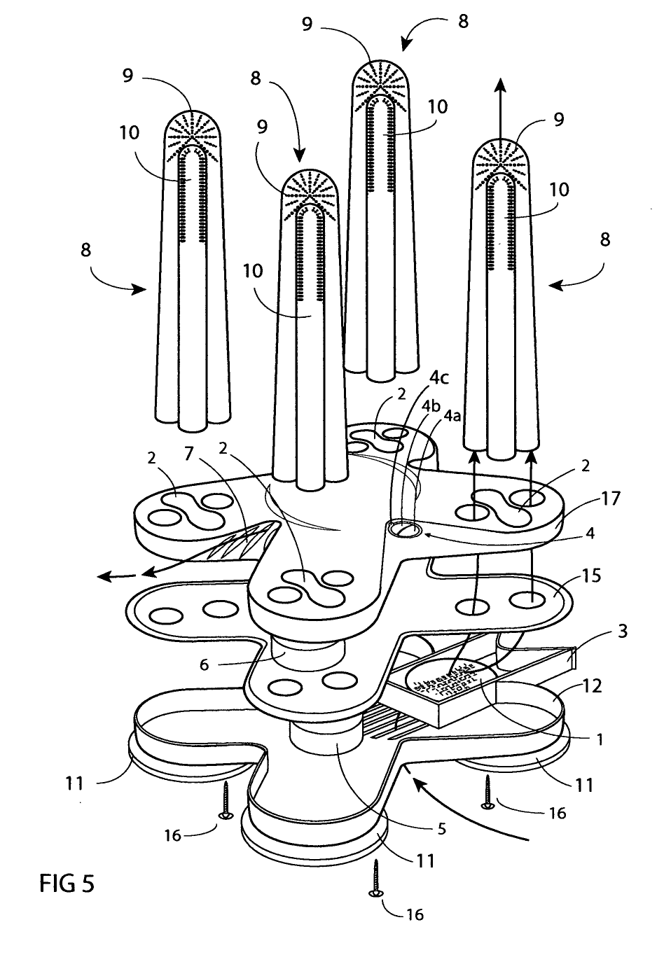

### DETAILED DESCRIPTION OF THE INVENTION

This apparatus stands erect and is rigid in structure. It has two fans: one blows in fresh filtered air while the other simultaneously vacuums and exhausts foul air from within the athletic gear. The air moves through separated flow-chambers within four upright air exchanger posts that support the gear.

The base plate 12 and base stabilizers 11 are made of a rigid plastic structure. The top plate 17 of the Ultimate Gear Dryer is attached to the base plate 12 with machine screws 16 and entraps the rubber middle plate 15. All four upright air exchanger posts 8 snap into sockets 2 in the top plate 17 and can be removed for compact portability. A 120 volt power cord 13 extends from the dryer and can be plugged into a standard wall socket. The 120 volt electrical power will be used to provide power to the blower fan 5, the exhaust fan 6, the switch assembly 4 made of two on/off dryer switches 4a and 4b and time selection dial 4c. When depressed the front dryer switch 4a simultaneously turns the power and fans on while it opens airflow for the two front air exchanger posts 8, while the back dryer switch 4b does likewise for the two rear air exchanger posts 8. The time selection dial 4c determines the length of time that the unit will remain on. When the preset drying time has elapsed the depressed switch(es) will pop back up and the unit will automatically power off. To activate the Ultimate Gear Dryer, plug it in to a standard wall socket, place athletic gear on the desired air exchanger posts 8, select desired drying time with time selection dial 4c, and depress the correlated dryer switch(es) 4a and/or 4b. The two fans 5 and 6 work simultaneously. When turned on by the dryer switch(es) 4a and/or 4b, the blower fan 5 will suck fresh air in from under the unit, drawing it through the air-filter 1, which is seated in the filter tray 15. The filtered forced air will flow through separated channels formed within the device by the base plate 12, the middle plate 15 and the top plate 17. The air will then be directed to two or all four air exchanger posts 8, depending on which dryer switches 4 are depressed. The filtered air is then forced out vents in the tips of the blower manifolds 9 where it enters the athletic gear. As the clean filtered air inside the athletic gear is circulating from the blower fan 5, the exhaust fan 6 is simultaneously sucking foul-stale air originating inside the athletic gear through vents in the tips of the exhaust manifolds 10, through the exhaust fan 6 and expelling it out of the apparatus via the exhaust ports 7. Both the blower fan 5 and exhaust fan 6 come on at the same time. This double fan arrangement, called the air blower/exhaust exchanger system allows for sanitized air to be introduced into athletic gear and any contaminated air to be quickly discharged from the gear. This will allow for dryer athletic gear that is free from bacteria and staff infections caused by moisture buildup. The Ultimate Gear Dryer is a clamshell type construction. The unit is made mainly of plastic parts with the exception of the filter, fans, dryer switch assemblies, machine screws, and power cord.

1. Claim a device that draws air through a filter and blows the filtered air into supported athletic gear in an effort to safely dry the inside of the gear.

2. Claim a device that combines mechanical suction of stale air from inside supported athletic gear with the blowing of air that has been passed through a filter into the athletic gear.

3. Claim a device that draws air through a scented deodorizer filter and blows the scented and filtered air into supported athletic gear.
